(19) United States
(12) Patent Application Publication
(10) Pub. No.: US 2015/0070362 A1
(43) Pub. Date: Mar. 12, 2015

(54) INFORMATION DISPLAY DEVICE, DISPLAY SWITCHING METHOD, AND DISPLAY SWITCHING PROGRAM

(71) Applicant: Masato Hirai, Tokyo (JP)

(72) Inventor: Masato Hirai, Tokyo (JP)

(73) Assignee: Mitsubishi Electric Corporation, Tokyo (JP)

(21) Appl. No.: 14/391,401

(22) PCT Filed: Jul. 20, 2012
(86) PCT No.: PCT/JP2012/004631

§ 371 Date: Oct. 9, 2014

(51) Int. Cl. G06T 13/80

(52) U.S. Cl. CPC G06T 13/80
USPC 345/475

(57) ABSTRACT

A transition path determinator 4 determines a transition path leading from a current screen which an output unit 9 is currently displaying to a transition destination screen for which the transition path determinator accepts a shortcut operation from a user via an input unit 1 with reference to a hierarchical structure which a transition table storage 3 stores. An animation-during-transition acquiring unit 5 acquires each animation during transition included in the transition path from an animation-during-transition table storage 6, an animation-during-transition controller 7 controls a playback speed according to the number of hierarchical layers transitioned in the transition path, and an output unit 9 displays the animation during transition in order at the playback speed, so that a transition to the transition destination screen is made.

### FIELD OF THE INVENTION

The present invention relates to an information display device, a display switching method, and a display switching program that expresses a screen transition in a GUI (graphical user interface) by using an animation.

### BACKGROUND OF THE INVENTION

In a GUI having menus (functions) with a hierarchical structure, the depth of the layered hierarchy increases with increase in the number of menus. Therefore, the number of times that the user performs an operation until he or she arrives at a target screen or a target function increases, and the time required for the user to complete operations becomes long. Therefore, there has been provided a technique of preparing a shortcut operations using a shortcut button, a voice input, or the like in order to reduce the number of times that an operation is performed. However, because a screen transition to a shortcut destination is momentarily made also in the case of a shortcut operation, like in the case of a normal operation, it is difficult for the user to understand via which path the shortcut transition has been made.

To solve this problem, for example, patent reference 1 discloses a technique of expressing a transition path leading from a screen currently being displayed, passing through all screens, and finally extending up to the screen which is the shortcut destination by using animation, thereby enabling the user to grasp the hierarchical structure of menus.

### RELATED ART DOCUMENT

### Patent Reference

Patent reference 1: Japanese Unexamined Patent Application Publication No. 2008-27009

### SUMMARY OF THE INVENTION

### Problems to be Solved by the Invention

However, when the hierarchical layer in which the shortcut destination exists is deep and the transition path is long, the time of the animation also becomes long. A problem is therefore that the user cannot perform the next operation until the animation is completed, and the ease of use is impaired.

The present invention is made in order to solve the above-mentioned problem, and it is therefore an object of the present invention to provide an information display device, a display switching method, and a display switching program that can ensure user convenience by expressing a transition path by using an animation while not impairing the ease of use thereof.

### Means for Solving the Problem

In accordance with the present invention, there is provided an information display device including: a transition table storage that stores a transition order of a plurality of objects; an animation-during-transition table storage that stores animations during transition each of which is to be displayed when moving a focus from an arbitrary object to a next object according to the transition order; an inputter that accepts a specification of an object to which the focus is to be moved from outside the information display device; a transition path determinator that determines a transition path leading from an object on which the focus is currently put to the transition destination object for which the focus specification is accepted by the inputter on the basis of the transition order; an animation-during-transition acquiring unit that acquires an animation during transition of each object existing on the transition path determined by the transition path determinator from the animation-during-transition table storage; an animation-during-transition controller that controls a playback speed of each animation during transition acquired by the animation-during-transition acquiring unit according to either the number of objects existing on the transition path determined by the transition path determinator or the sum total of the time duration of each animation during transition mentioned above; and an outputter that displays each animation during transition acquired by the animation-during-transition acquiring unit at the playback speed controlled by the animation-during-transition controller when moving the focus from the object on which the focus is currently put to the object which is the transition destination.

In accordance with the present invention, there is provided a display switching method including: an inputting step of accepting a specification of an object, among a plurality of objects for which a transition order is defined, on which a focus is to be put from outside; a transition path determining step of determining a transition path leading from an object on which the focus is currently put to the transition destination object for which the focus specification is accepted in the inputting step on the basis of the transition order; an animation-during-transition acquiring step of acquiring an animation during transition of each object existing on the transition path determined in the transition path determining step from an animation-during-transition table storage that stores animations during transition each of which is to be displayed when moving the focus from an arbitrary object to a next object according to the transition order; an animation during transition controlling step of controlling a playback speed of each animation during transition acquired in the animation-during-transition acquiring step according to either the number of objects existing on the transition path determined in the transition path determining step or the sum total of the time duration of each animation during transition mentioned above; and an outputting step of displaying each animation during transition acquired in the animation-during-transition acquiring step at the playback speed controlled in the animation-during-transition controlling step when moving the focus from the object on which the focus is currently put to the object which is the transition destination.

In accordance with the present invention, there is provided a display switching program for making a computer implement: a transition table storage that stores a transition order of a plurality of objects; an animation-during-transition table storage that stores animations during transition each of which is to be displayed when moving a focus from an arbitrary object to a next object according to the transition order; an inputter that accepts a specification of an object to which the focus is to be moved from outside the display switching program; a transition path determinator that determines a transition path leading from an object on which the focus is currently put to the transition destination object for which the focus specification is accepted by the inputter on the basis of the transition order; an animation-during-transition acquiring unit that acquires an animation during transition of each object existing on the transition path determined by the transition path determinator from the animation-during-transition table storage; an animation-during-transition controller that controls a playback speed of each animation during transition acquired by the animation-during-transition acquiring unit according to either the number of objects existing on the transition path determined by the transition path determinator or the sum total of the time duration of each animation during transition mentioned above; and an outputter that displays each animation during transition acquired by the animation-during-transition acquiring unit at the playback speed controlled by the animation-during-transition controller when moving the focus from the object on which the focus is currently put to the object which is the transition destination.

### Advantages of the Invention

According to the present invention, by controlling the playback speed of each animation during transition which is to be displayed when moving the focus from the object on which the focus is currently put to the object which is the transition destination according to either the number of objects existing on the transition path or the sum total of the duration of each animation during transition, the animation during transition can be completed quickly even when the transition path to the shortcut destination is long. Therefore, there can be provided an information display device, a display switching method, and a display switching program that can ensure user convenience by expressing a transition path by using an animation while not impairing the ease of use thereof.

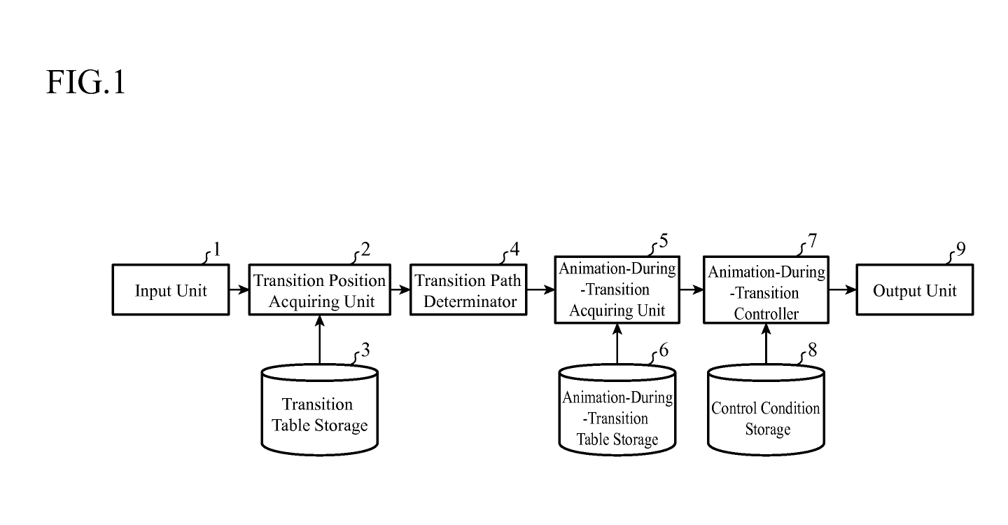

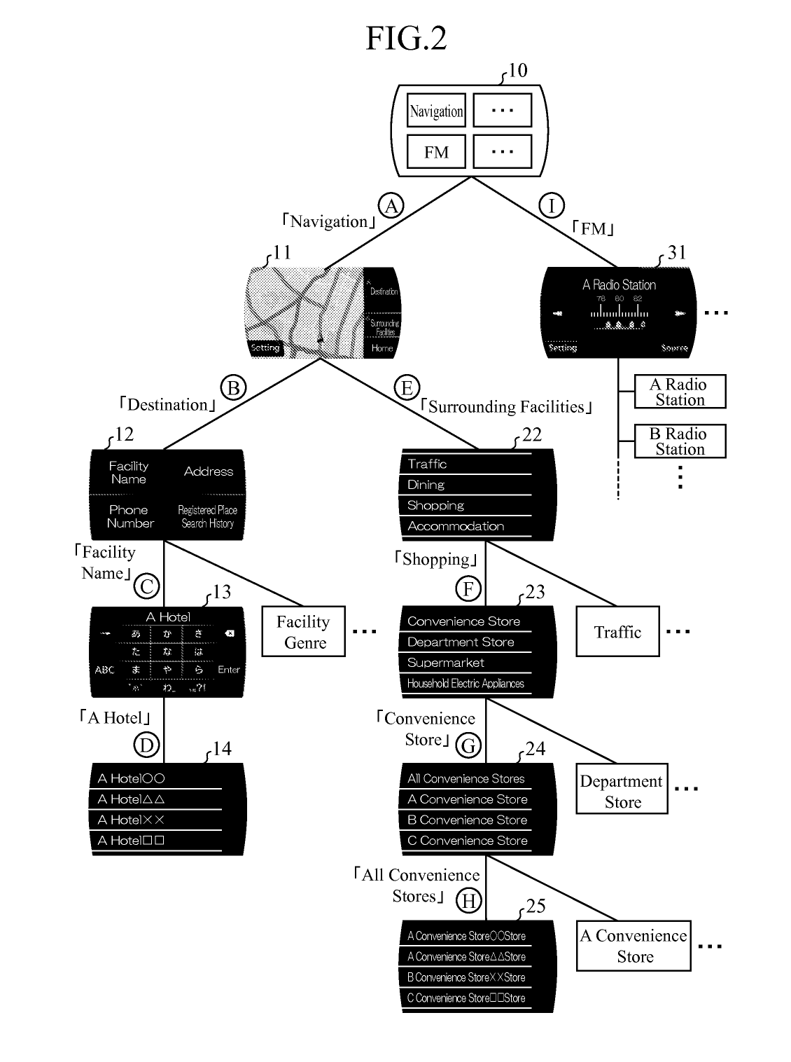

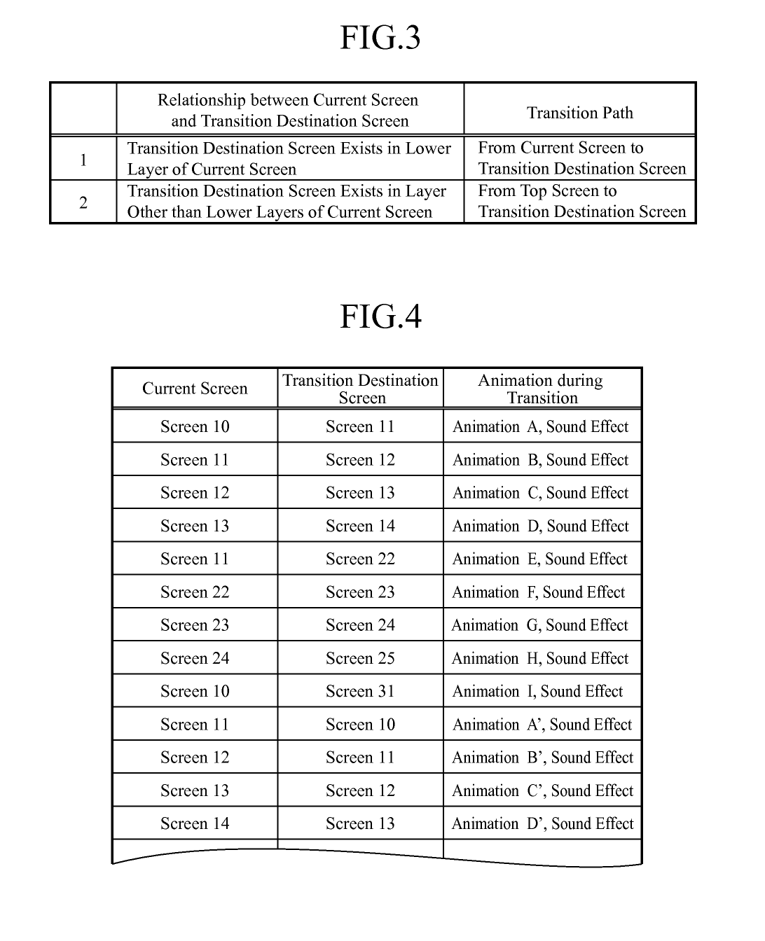

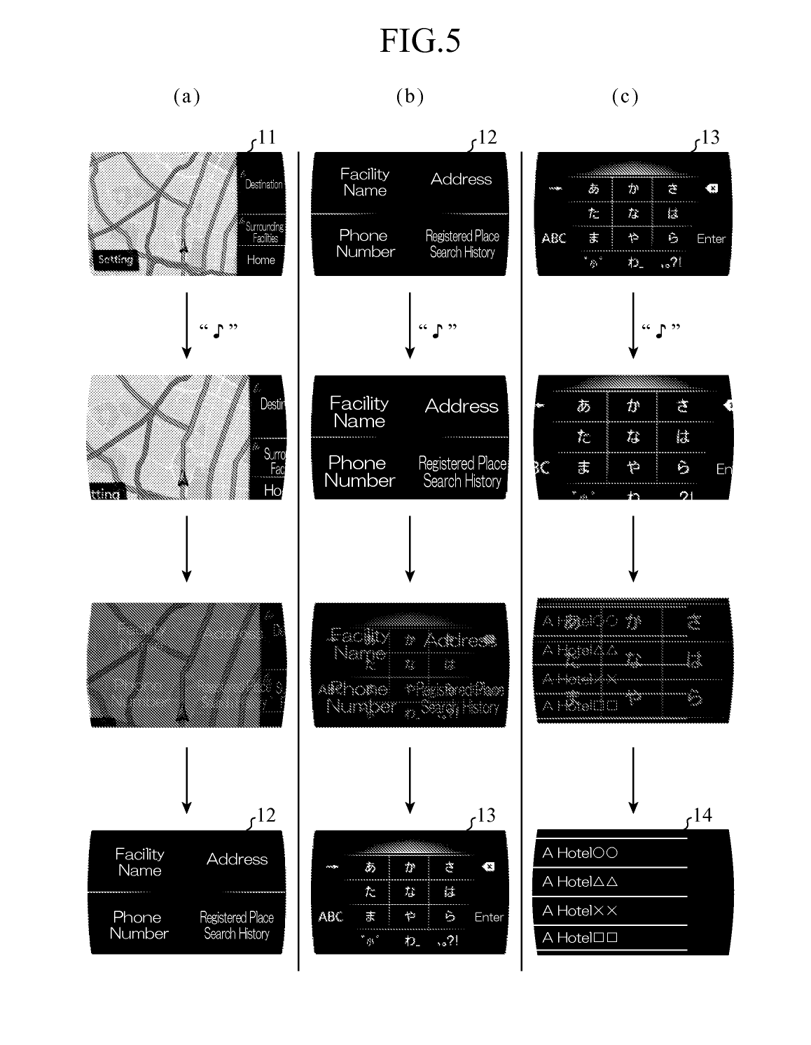

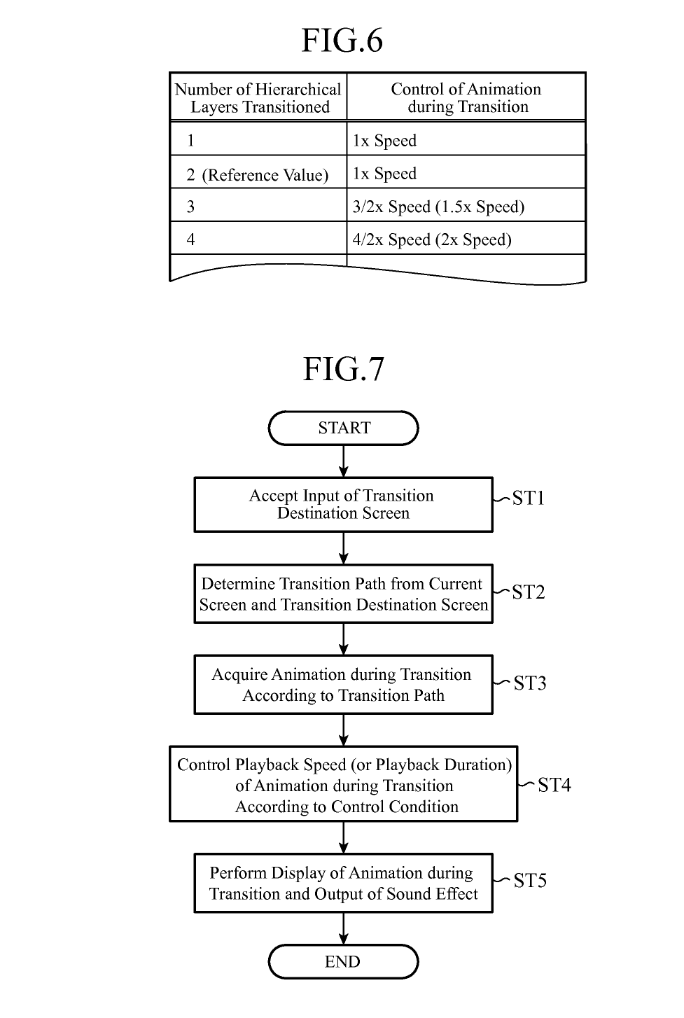

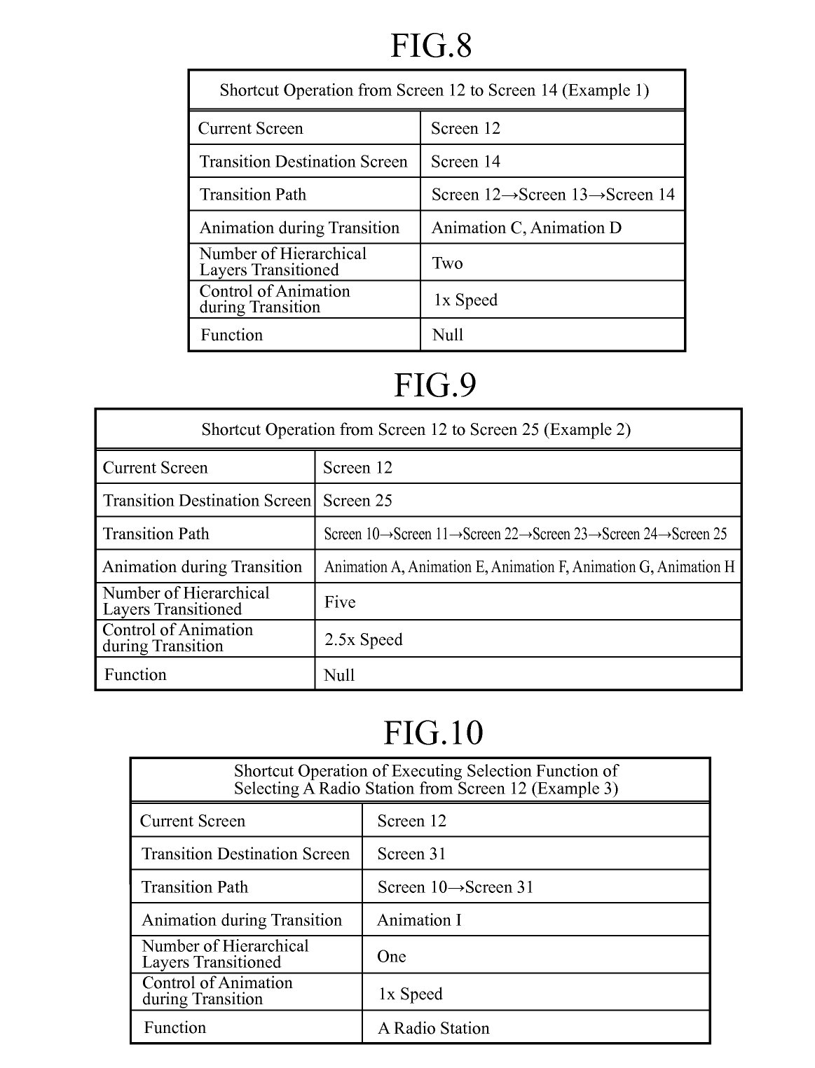

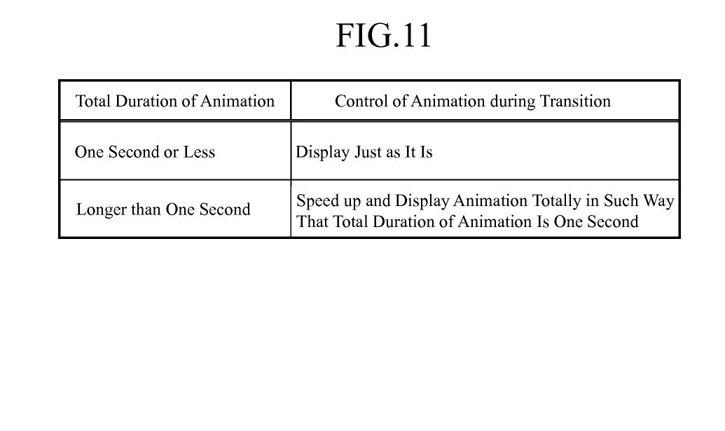

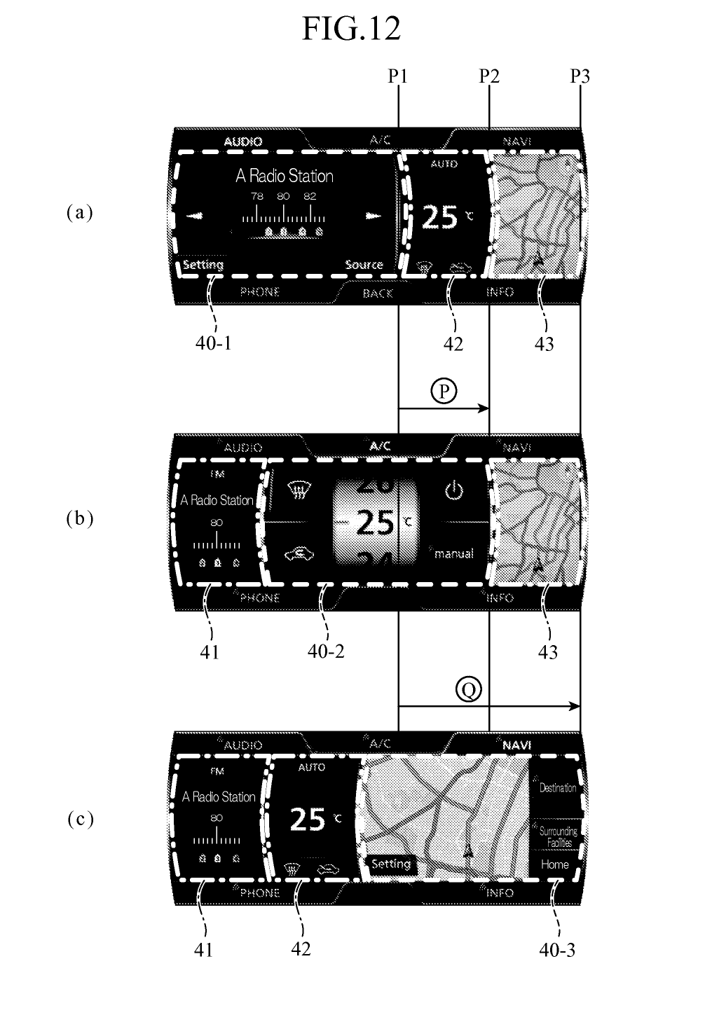

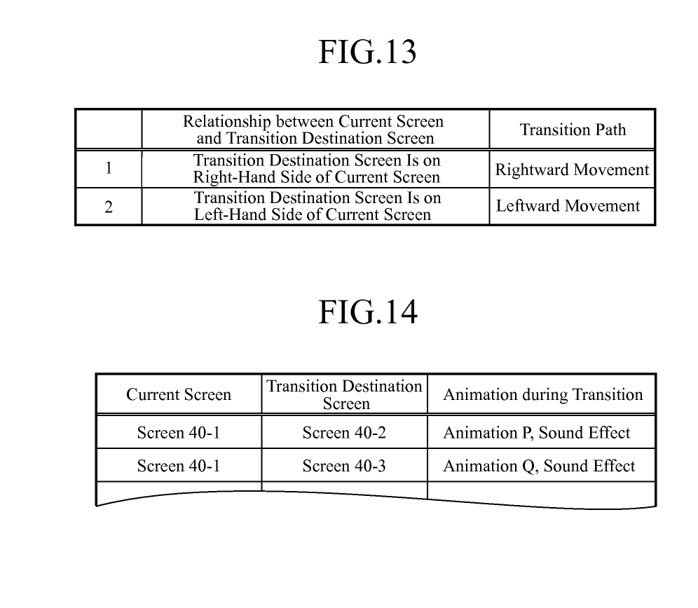

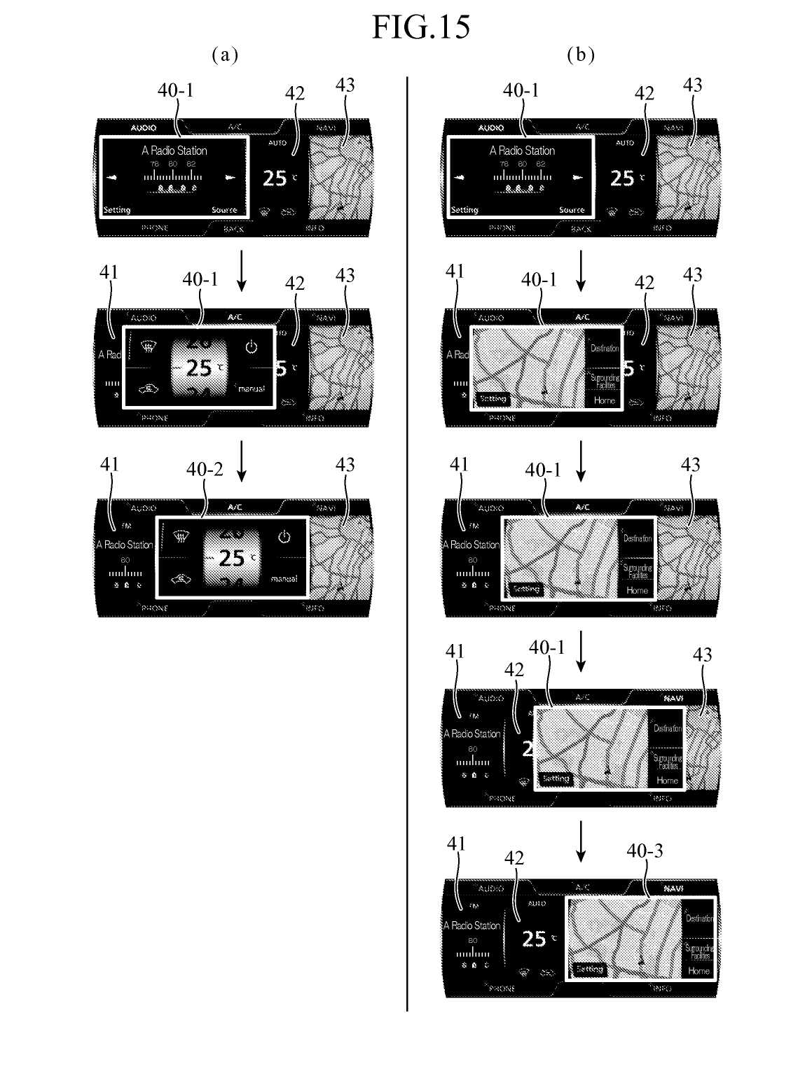

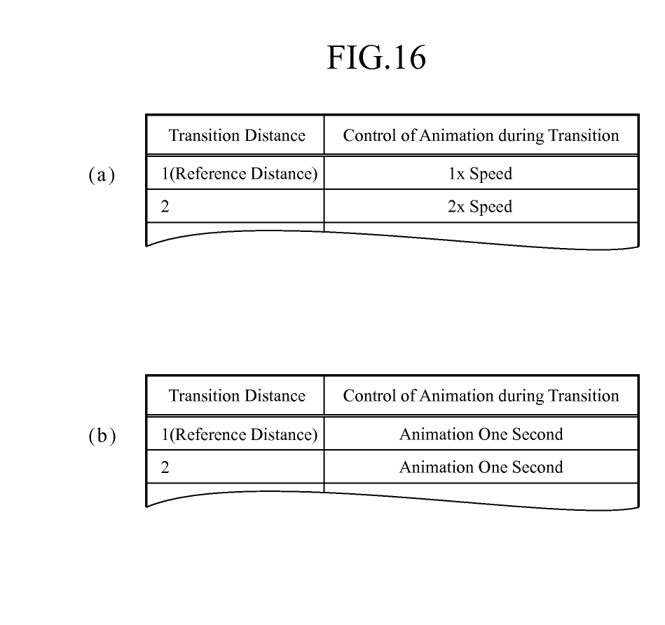

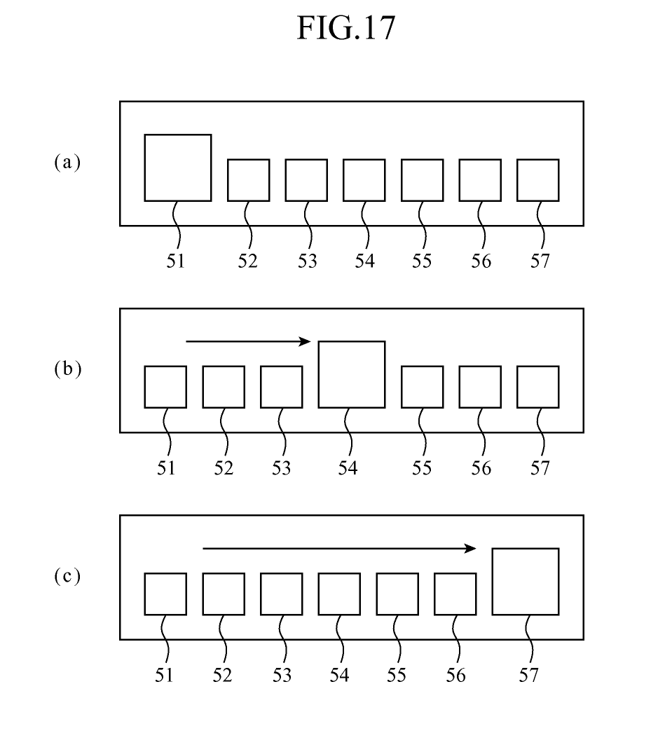

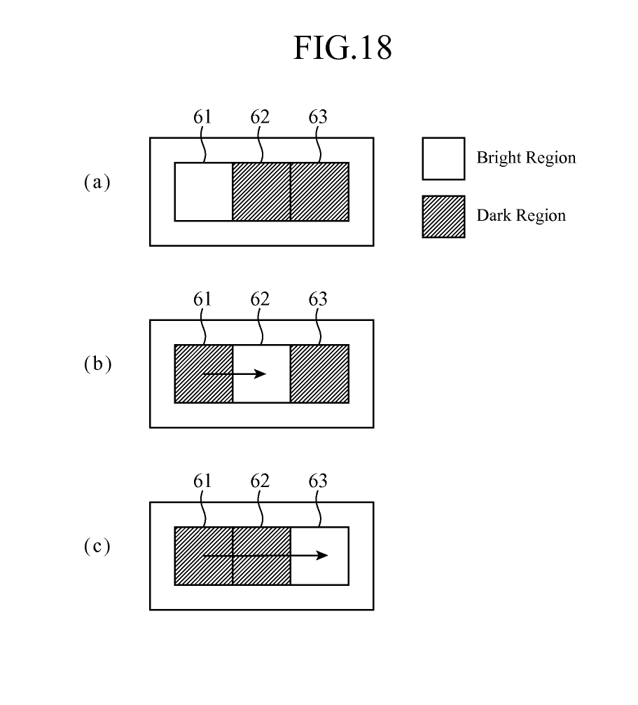

### BRIEF DESCRIPTION OF THE FIGURES

[FIG. 1] FIG. 1 is a block diagram showing the structure of an information display device according to Embodiment 1 of the present invention;

[FIG. 2] FIG. 2 is a schematic diagram of a transition table which a transition table storage according to Embodiment 1 holds;

[FIG. 3] FIG. 3 is a view showing rules for transition path determination which a transition path determinator according to Embodiment 1 holds;

[FIG. 4] FIG. 4 is a view showing an animation-during-transition table which an animation-during-transition table storage according to Embodiment 1 stores;

[FIG. 5] FIG. 5 is a view showing a concrete example of an animation during transition;

[FIG. 6] FIG. 6 is a view showing control conditions which a control condition storage according to Embodiment 1 stores;

[FIG. 7] FIG. 7 is a flow chart showing the operation of the information display device in accordance with Embodiment 1;

[FIG. 8] FIG. 8 is a view showing an information list which the information display device generates at the time of a shortcut operation (Example 1);

[FIG. 9] FIG. 9 is a view showing an information list which the information display device generates at the time of a shortcut operation (Example 2);

[FIG. 10] FIG. 10 is a view showing an information list which the information display device generates at the time of a shortcut operation (Example 3);

[FIG. 11] FIG. 11 is a view showing another example of control conditions which the control condition storage according to Embodiment 1 stores;

[FIG. 12] FIG. 12 is an example of a display screen of a car navigation system to which an information display device in accordance with Embodiment 2 of the present invention is applied;

[FIG. 13] FIG. 13 is a view showing rules for transition path determination which a transition path determinator according to Embodiment 2 holds;

[FIG. 14] FIG. 14 is a view showing an animation-during-transition table which an animation-during-transition table storage according to Embodiment 2 stores;

[FIG. 15] FIG. 15 is a view showing a concrete example of an animation during transition;

[FIG. 16] FIG. 16 is a view showing control conditions which a control condition storage according to Embodiment 2 stores;

[FIG. 17] FIG. 17 is another example of a display screen of the information display device in accordance with Embodiment 2; and

[FIG. 18] FIG. 18 is another example of a display screen of the information display device in accordance with Embodiment 2.

### EMBODIMENTS OF THE INVENTION

Hereafter, in order to explain this invention in greater detail, the preferred embodiments of the present invention will be described with reference to the accompanying drawings.

### Embodiment 1

An information display device shown in FIG. 1 is comprised of an input unit 1, a transition position acquiring unit 2, a transition table storage 3, a transition path determinator 4, an animation-during-transition acquiring unit 5, an animation-during-transition table storage 6, an animation-during-transition controller 7, a control condition storage 8, and an output unit 9. Hereafter, the information display device will be explained by using, as an example, a case in which this information display device is applied to a car navigation system (referred to as car navigation from here on).

A hierarchical structure of screens and functions which the car navigation has is shown in FIG. 2. Screens connected to each other via a solid line shown in FIG. 2 have a hierarchical structure with a child-parent relationship in which there is a relationship between functions. Further, screens and functions existing further upward on the page of the figure are arranged in a higher hierarchical layer, while screens and functions existing further downward on the page are arranged in a lower hierarchical layer.

In this Embodiment 1, it is assumed that an object is a screen or a function, and a transition order having a hierarchical structure is defined.

It is further assumed that a screen or a function on which a focus is currently put is displayed on the entire screen of the output unit 9.

A top screen 10 in the highest hierarchical layer is an initial screen displayed at the time when the car navigation is started, and menu buttons, such as navigation and FM buttons, are displayed in the top screen. When the navigation button in the top screen 10 is operated, the information display device makes a transition to a navigation menu screen 11 in a lower layer. On the other hand, when the FM button is operated, the information display device makes a transition to an FM radio listen screen 31.

In the navigation menu screen 11, while an image of a map of an area in the vicinity of the vehicle is displayed, a destination button for executing a function of searching for a destination, a surrounding facility button for executing a function of searching for surrounding facilities, and a home button for executing a function of displaying an image of a map of an area in the vicinity of the home registered in advance are displayed.

For example, when the user wants to search for hotels in a specific brand (e.g., A hotels), he or she presses down the destination button of the navigation menu screen 11 to cause the information display device to make a transition to a destination search menu screen 12 in a lower layer, and then presses down a facility name button to cause the information display device to make a transition to a facility name search screen 13. Next, the user makes a character input of “A hotel” to cause the information display device to make a transition to a facility name search result screen 14.

Further, for example, when the user wants to search for convenience stores in the vicinity of the current position, he or she presses down the surrounding facility button of the navigation menu screen 11 to cause the information display device to make a transition to a surrounding facility list screen 22 in a lower layer, then presses down an item of “Convenience Store” to cause the information display device to make a transition to a convenience store list screen 24, and further presses down an item of “All Convenience Stores” to cause the information display device to make a transition to an all-convenience-stores list screen 25.

On the other hand, a function of selecting an A radio station, a function of selecting a B radio station, etc. are linked to the FM radio listen screen 31. When the user wants to listen to the A radio station, he or she presses down the FM button of the top screen 10 to cause the information display device to make a transition to the FM radio listen screen 31, and performs an operation of selecting the A radio station on this FM radio listen screen 31 to cause the information display device to execute the function.

In a normal operation, the user causes the information display device to make a transition between screens on a one-hierarchical-layer-by-one-hierarchical-layer basis to reach the target screen, and to execute the target function in this way. In contrast, in a shortcut operation, a simple operation of pressing down a button or making a voice input of a keyword makes it possible to directly call the target screen or execute the target function. For example, when the user utters “A hotel” in the destination search menu screen 12, the car navigation makes a transition from the destination search menu screen 12 directly to the facility name search result screen 14 (Example 1 which will be mentioned below). Further, for example, when the user utters “convenience store” in the destination search menu screen 12, the car navigation makes a transition from the destination retrieval menu screen 12 directly to the all-convenience-stores list screen 25 (Example 2). Further, for example, when the user utters “A radio station” in the destination search menu screen 12, the car navigation makes a transition directly to the FM radio listen screen 31, and performs a channel selection of the A radio station (Example 3).

At the time of such a shortcut operation, the information display device produces an animated display of a transition path leading from the screen under display or the screen of the function under execution to the transition destination screen specified by the user in such a way that the user easily grasps the hierarchical structure.

The information display device connects with I/O devices, such as a touch display in which a touch panel and a display are integral with each other, a microphone, and a speaker, to perform input and output of information. In this embodiment, the touch panel and the microphone are used as the input unit 1, and the display and the speaker are used as the output unit 9. The input unit 1 accepts information about the transition destination screen on which the user has performed operational input, and outputs the information to the transition position acquiring unit 2. The transition position acquiring unit 2 acquires a relationship between the hierarchical layer of either the screen under display or the screen of the function under execution (either of them is referred to as the current screen from here on), and the hierarchical layer of the transition destination screen according to a user operation from the transition table storage 3. The transition table storage 3 stores the hierarchical structure of all the screens and a link between each of the screens and functions, as shown in FIG. 2.

When determining that the transition destination screen is located in a lower layer of the current screen on the basis of the hierarchical relationship, which the transition position acquiring unit 2 acquires, between the current screen and the transition destination screen, the transition path determinator 4 defines screens including from the current screen up to the transition destination screen as a transition path. In contrast, when the transition destination screen is located in a layer other than lower layers of the current screen, the transition path determinator defines screens including from the top screen 10 in the highest hierarchical layer up to the transition destination screen as a transition path. Rules for the transition path determinator 4 are shown in FIG. 3.

In the example shown in FIG. 3, although the start point of the transition path is set to the screen in the highest hierarchical layer when the transition destination screen is located in a layer other than lower layers of the current screen, the start point is not limited to this example. For example, the transition path determinator can alternatively return from the current screen to the screen in the highest hierarchical layer temporarily, and define a transition path leading from there to the transition destination screen. As an alternative, for example, when the current screen is a navigation-associated screen (e.g., the destination search menu screen 12), the transition path determinator can set the navigation menu screen corresponding to the highest navigation-associated hierarchical layer as the start point of the transition path.

The animation-during-transition acquiring unit 5 acquires a necessary animation during transition from the animation-during-transition table storage 6 according to the transition path which the transition path determinator 4 determines. The animation-during-transition table storage 6 stores animations during transition and sound effects between screens. An animation-during-transition table stored in the animation-during-transition table storage 6 is shown in FIG. 4. For example, an animation A and a sound effect are stored as an animation during transition which is displayed on the screen when a transition from the top screen 10 to the navigation menu screen 11 is made, whereas an animation A′ and a sound effect are stored as an animation during transition which is displayed on the screen when a transition from the navigation menu screen 11 to the top screen 10 is made. It is assumed that the time required to play back each animation is the same.

Concrete examples of an animation during transition are shown in FIG. 5. FIG. 5(a) represents a change with time of an animation B at the time when a transition from the navigation menu screen 11 to the destination search menu screen 12 is made, FIG. 5(b) represents a change with time of an animation C at the time when a transition from the destination search menu screen 12 to the facility name search screen 13 is made, and FIG. 5(c) represents a change with time of an animation D at the time when a transition from the facility name search screen 13 to the facility name search result screen 14 is made. For example, when a transition from the navigation menu screen 11 to the destination search menu screen 12 is made, the animation changes in such a way that the navigation menu screen 11 becomes lighter in color while being enlarged gradually, and the destination search menu screen 12 which is the transition destination rises to the foreground from under the navigation menu screen. Further, at the time when a transition to the destination search menu screen 12 is started (at a time shown by a musical note mark in the figure) or at a time like that, a sound effect is outputted. Such an expression of the animation during transition can achieve a visual effect in a depth direction of causing the user to feel as if he or she could advance inside the screen from the navigation menu screen 11 to the destination search menu screen 12 in a state in which the screens in the deep hierarchical layers are arranged along the depth direction perpendicular to the screen of the output unit 9, thereby making it easy for the user to intuitively grasp that the display has transitioned to the screen in a lower hierarchical layer.

In contrast, when a transition to the screen in a higher hierarchical layer is made, for example, the animation can be expressed to change in such a way that the destination search menu screen 12 becomes lighter in color while being reduced gradually and the navigation menu screen 11 which is the transition destination rises to above the destination search menu screen, thereby making it easy for the user to intuitively grasp that the display has transitioned to the screen in a higher hierarchical layer. As an alternative, the animation of FIG. 5 can be simply played back reversely. Further, a sound effect at the time of making a transition to a lower hierarchical layer can be made to be different from that at the time of making a transition to a higher hierarchical layer.

The animation-during-transition controller 7 controls the playback speed of the animation during transition which the animation-during-transition acquiring unit 5 acquires according to a control condition which the control condition storage 8 stores. The control condition storage 8 stores the control condition for determining the playback speed of an animation during transition. The control condition which the control condition storage 8 stores is shown in FIG. 6. In this example, it is assumed that the playback speed is determined according to the number of hierarchical layers transitioned (i.e., the number of objects), the animation is played back at a 1× speed when the number of hierarchical layers transitioned is two or less with the number of hierarchical layers transitioned=2 being set as a reference value. When the number of hierarchical layers transitioned is one (normal operation), the animation playback is completed more quickly than that at the time of the number of hierarchical layers transitioned=2. On the other hand, when the number of hierarchical layers transitioned is larger than two, the playback speed is increased and control is performed in such a way that, even if the number of hierarchical layers transitioned is increased to the value, the animation playback is completed in the same time as that at the time of a transition across two hierarchical layers.

The output unit 9 produces a screen display of the animation during transition whose playback speed is controlled by the animation-during-transition controller 7, and outputs the sound effect at a time suited to the playback speed.

Next, the operation of the information display device will be explained by using a flow chart shown in FIG. 7.

### EXAMPLE 1

### In the Case of an Operation of Taking a Shortcut from the Destination Search Menu Screen 12 to the Facility Name Search Result Screen 14

FIG. 8 shows an information list which the information display device generates at the time of the shortcut operation of Example 1.

When the input unit 1 accepts an operation of taking a shortcut to the facility name search result screen 14 while the output unit 9 displays the destination search menu screen 12 (step ST1), the transition position acquiring unit 2 refers to the transition table storage 3, acquires a hierarchical relationship between the destination search menu screen 12 which is the current screen and the facility name search result screen 14 which is the transition destination screen, and the transition path determinator 4 determines a transition path according to the rules shown in FIG. 3 (step ST2). In this Example 1, because the facility name search result screen 14 is located in a layer lower of the destination search menu screen 12, the transition path is determined as screen 12→screen 13→screen 14.

The animation-during-transition acquiring unit 5 then acquires the animation C corresponding to screen 12—screen 13 and its sound effect, and the animation D corresponding to screen 13—screen 14 and its sound effect from the animation-during-transition table storage 6 (step ST3). Because the number of hierarchical layers transitioned is two, the animation-during-transition controller 7 controls the playback speed to the 1× one according to the control condition stored in the control condition storage 8 (step ST4), and the output unit 9 produces a screen display of the animations C and D in order at the 1× speed and also outputs the sound effects at the following two times in total: at a time when the screen changes from the destination search menu screen 12 to the facility name search screen 13 and at a time when the screen changes from the facility name search screen 13 to the facility name search result screen 14 (step ST5).

### EXAMPLE 2

### In the Case of an Operation of Taking a Shortcut from the Destination Search Menu Screen 12 to the All-Convenience-Stores List Screen 25

FIG. 9 shows an information list which the information display device generates at the time of the shortcut operation of Example 2.

When the input unit 1 accepts an operation of taking a shortcut to the all-convenience-stores list screen 25 while the output unit 9 displays the destination search menu screen 12 (step ST1), the transition position acquiring unit 2 acquires a hierarchical relationship between the destination search menu screen 12 and the all-convenience-stores list screen 25 with reference to the transition table storage 3, and the transition path determinator 4 determines a transition path according to the rules shown in FIG. 3 (step ST2). In this Example 2, because the all-convenience-stores list screen 25 is not located in any lower layer of the destination search menu screen 12, the transition path is determined as screen 10→screen 11→screen 22→screen 23→screen 24→screen 25.

The animation-during-transition acquiring unit 5 then acquires the animation A corresponding to screen 10→screen 11 and its sound effect, an animation E corresponding to screen 11→screen 22 and its sound effect, an animation F corresponding to screen 22→screen 23 and its sound effect, an animation G corresponding to screen 23→screen 24 and its sound effect, and an animation H corresponding to screen 24→screen 25 and its sound effect from the animation-during-transition table storage 6 (step ST3). Because the number of hierarchical layers transitioned is five, the animation-during-transition controller 7 controls the playback speed to a 2.5× one according to the control condition stored in the control condition storage 8 (step ST4), and the output unit 9 produces a screen display of the animations A, E, F, G, and H in order at the 2.5× speed and also outputs the sound effects at five times in total at each of which the screen changes (step ST5).

### EXAMPLE 3

### A Shortcut Operation of Executing a Channel Selection Function of Selecting a Radio Station A from the Destination Search Menu Screen 12

FIG. 10 shows an information list which the information display device generates at the time of the shortcut operation of Example 3.

When the input unit 1 accepts a command for execution of the channel selection function of selecting the A radio station while the output unit 9 displays the destination search menu screen 12 (step ST1), the transition position acquiring unit 2 acquires a hierarchical relationship between the destination search menu screen 12 which is the current screen, and the FM radio listen screen 31 which is the transition destination screen and which is linked with the channel selection function of selecting the A radio station with reference to the transition table storage 3, and the transition path determinator 4 determines a transition path according to FIG. 3 (step ST2). In this Example 3, because the FM radio listen screen 31 is not located in any lower layer of the destination search menu screen 12, the transition path is determined as screen 10→screen 31.

Next, the animation-during-transition acquiring unit 5 acquires an animation I corresponding to screen 10→screen 31, and its sound effect from the animation-during-transition table storage 6 (step ST3). Because the number of hierarchical layers transitioned is one, the animation-during-transition controller 7 controls the playback speed to the 1× one according to the control condition stored in the control condition storage 8 (step ST4), and the output unit 9 produces a screen display of the animation I at the 1× speed, and also outputs the sound effect once at a time which the screen changes (step ST5).

By producing an animated display of the transition path at the time of a shortcut operation, like in the case of Examples 1 to 3, the information display device enables the user to intuitively feel that the shortcut has been performed. Further, by displaying the animation during transition, the information display device enables the user to grasp the hierarchical structure including up to the shortcut destination and makes it easy for the user to understand to which screen the display has been shortcutted. Therefore, the user's convenience can be improved. Further, because the animation during transition is completed quickly even when a shortcut operation of making a transition passing a deep hierarchical layer is performed, like in the case of Examples 1 and 2, the information display device can prevent the user from waiting to perform the next operation, and hence does not impair the ease of use thereof. In addition, by changing the playback speed of the animation during transition and the time intervals at which the sound effect is played back according to the number of hierarchical layers transitioned, the information display device makes it easy for the user to grasp the depth of the hierarchical layer of the shortcut destination. Further, by playing back the sound effect with a good tempo, the information display device can also provide the pleasantness of the shortcut operation.

Although the animation-during-transition controller 7 is structured in such a way as to control the playback speed of the animations during transition according to the number of hierarchical layers transitioned in the above-mentioned explanation, the animation-during-transition controller can be alternatively structured in such a way as to control a playback time duration. Hereafter, the example in which the animation-during-transition controller controls the playback time duration will be explained briefly.

The control condition which the control condition storage 8 stores is shown in FIG. 11. The playback speed of each animation during transition is determined according to the sum total of the playback time durations of the animations during transition, and, in this case, each animation is played back at the 1× speed when the total time duration is one second or less with a total time of one second being defined as a reference value. In contrast, when the total time duration is longer than one second, a control operation of increasing the playback speed of each animation during transition is performed in such a way that the total time duration is equal to one second.

The animation-during-transition controller 7 controls the playback speed of each animation during transition which the animation-during-transition acquiring unit 5 acquires according to this control condition. For example, in the case of above-mentioned Example 1, when the total time duration of the animations C and D is one second or less, the animation-during-transition controller 7 controls the playback speed to the 1× one, and the output unit 9 produces a screen display of the animations C and D in order at the 1× speed. In contrast, when the total time duration is longer than one second, the animation-during-transition controller 7 calculates the playback speed which makes the total time duration be equal to one second, and produces a screen display of the animations C and D in order at the playback speed which the output unit 9 calculates.

In the case of this structure, even if the playback time duration of each animation during transition is not the same, there is provided a merit of being able to certainly complete the playback within the predetermined time period.

As mentioned above, the information display device according to Embodiment 1 is structured in such a way as to include: the transition table storage 3 that stores a hierarchical structure of a plurality of screens and functions;

the animation-during-transition table storage 6 that stores animations during transition each of which is to be displayed when make a transition from an arbitrary screen or function to a next screen or function according to the hierarchical structure; the input unit 1 that accepts a specification of a transition destination screen or function from the user; the transition position acquiring unit 2 that acquires a hierarchical relationship between the current screen and the transition destination screen from the transition table storage 3; the transition path determinator 4 that determines a transition path leading from the current screen to the transition destination screen on the basis of the hierarchical structure stored in the transition table storage 3; the animation-during-transition acquiring unit 5 that acquires the animation during transition between the screens existing on the transition path which the transition path determinator 4 determines from the animation-during-transition table storage 6; the animation-during-transition controller 7 that controls the playback speed of each animation during transition which the animation-during-transition acquiring unit 5 acquires according to either the number of hierarchical layers transitioned and existing on the transition path which the transition path determinator 4 determines or the sum total of the duration of each animation during transition mentioned above; and the output unit 9 that, when taking a shortcut from the current screen to the transition destination screen, displays each animation during transition which the animation-during-transition acquiring unit 5 acquires at the playback speed which the animation-during-transition controller 7 controls. Therefore, even when the hierarchical layers of the screens including from the current screen to the transition destination screen are deep, the animations during transition can be completed quickly. Therefore, user convenience can be ensured by expressing the transition path by using animations while the ease of use of the device is not impaired.

Further, the information display device according to Embodiment 1 is structured in such a way that the output unit 9 produces a screen display of only the screen, among a plurality of screens, which the user selects, and the animation-during-transition table storage 6 stores, as the animations during transition, animations each transitioning between screens arranged in the order of hierarchical layers toward a depth direction perpendicular to the screen of the output unit 9. Therefore, when taking a shortcut between screens having the hierarchical structure, there can be provided a visual effect of making a transition in the depth direction with respect to the screen according to the depths of hierarchical layers, thereby making it easy for the user to intuitively grasp the hierarchical structure.

Further, because the information display device according to Embodiment 1 is structured in such a way that the output unit 9 synchronously outputs the number of sound effects which is the same as the number of animations during transition, the information display device makes it easy for the user to intuitively grasp the hierarchical structure.

At the time of a screen transition resulting from a shortcut, the output of a sound effect is not indispensable, and only an animation during transition can be outputted.

### Embodiment 2

Although an example of control of an animated display produced at the time of making a transition from a certain screen to another screen while tracing a hierarchical structure is shown in above-mentioned Embodiment 1, the present invention is not limited to this example having a hierarchical structure, and it is also possible to control an animated display produced at the time of making a transition between screens having a parallel relationship and arranged in a transition order.

Hereafter, in this Embodiment 2, an example of control of an animation during transition in a case of arranging a plurality of objects in order according to the transition order and producing a screen display of the objects, and moving a focus from an object on which the focus is currently put to an object which is a transition destination will be explained. Because an information display device according to this Embodiment 2 has the same structure as the information display device shown in FIG. 1 from a graphical viewpoint, the information display device will be explained hereafter by using FIG. 1.

Examples of a screen which car navigation displays are shown in FIG. 12. In this embodiment, it is assumed that the car navigation has an audio function, an air conditioner control function, and a navigation function. A region enclosed by a dashed line in the oblong screen shown in FIG. 12 is a main screen 40 in which a screen display of a function on which the focus is currently put is produced in a large size, and regions each enclosed by a dashed dotted line are an audio sub screen 41, an air conditioner sub screen 42, and a navigation sub screen 43 in each of which a screen display of a function on which the focus is not put currently is produced in a small size. Hereafter, the main screen 40 is referred to as either one of main screens 40-1, 40-2, and 40-3 according to its display position.

In this Embodiment 2, it is assumed that the objects are the main screen and the sub screens, and the display appearance is changed from a sub screen to the main screen during focusing.

When the focus is put on the audio function, the main screen 40-1 is located at a position P1 in a left-hand side portion of the oblong screen, and an FM radio listen screen is displayed in this main screen 40-1, as shown in FIG. 12(a). When the air conditioner function is selected in this state, the main screen 40-1 passes above the air conditioner sub screen 42 and then moves to a position P2 in a central portion of the oblong screen while changing from the FM radio listen screen to an air conditioner control screen, so that the main screen 40-1 becomes the main screen 40-2 shown in FIG. 12(b). After the main screen 40-1 moves, the audio sub screen 41 appears from under the main screen.

When the navigation function is selected in the state shown in FIG. 12(b), the main screen 40-2 passes above the navigation sub screen 43 and then moves to a position P3 in a right-hand side portion of the oblong screen, so that the main screen 40-2 becomes the main screen 40-3 shown in FIG. 12(c). After the main screen 40-2 moves, the air conditioner sub screen 42 appears from under the main screen.

In contrast, when the navigation function is selected in the state shown in FIG. 12(a), the main screen 40-1 passes above the air conditioner sub screen 42 and the navigation sub screen 43, and moves to the position P3 in the right-hand side portion of the oblong screen while changing from the FM radio listen screen to the navigation menu screen, so that the main screen 40-1 becomes the main screen 40-3 shown in FIG. 12(c). After the main screen 40-1 moves, the audio sub screen 41 and the air conditioner sub screen 42 appear in order from under the main screen.

Although the movement distance which is moved by the main screen 40 when moving from the position P1 to the position P2 is twice as long as the movement distance which is moved by the main screen when moving from the position P1 to the position P3 in such a screen display structure, by equalizing the movement time of the main screen 40 regardless of the movement distance in this Embodiment 2, slowness can be prevented from occurring before the completion of playback of an animation during transition expressing the movement.

An input unit 1 accepts information about the function on which the user has performed an operational input and on which the focus is to be put from now on, and outputs the information to a transition position acquiring unit 2. When determining that the transition destination screen is located on a right-hand side of the current screen on the basis of a positional relationship between the position of the main screen of the function on which the focus is currently put and the position of the main screen of the function on which the focus is to be put from now on, the transition position acquiring unit 2 determines a transition path via which to move the main screen toward a rightward direction. In contrast, when the transition destination screen is located on a left-hand side of the current screen, the transition position acquiring unit determines a transition path via which to move the main screen 40 toward a leftward direction. Rules for a transition path determinator 4 are shown in FIG. 13.

An animation-during-transition acquiring unit 5 acquires a necessary animation during transition from an animation-during-transition table storage 6 according to the transition path which the transition path determinator 4 determines. The animation-during-transition table storage 6 stores animations during transition each expressing an appearance of movement of the main screen in the oblong screen from the position of the function on which the focus is currently put to the position of the function on which the focus is put the next time, and sound effects. An animation-during-transition table which the animation-during-transition table storage 6 stores is shown in FIG. 14. For example, an animation P and its sound effect are stored as an animation during transition which transitions from the current screen shown in FIG. 12(a) to the transition destination screen shown in FIG. 12(b).

Concrete examples of an animation during transition are shown in FIG. 15. FIG. 15(a) represents a change with time of the animation P at the time when the focus is transversely moved from the FM radio listen screen of the main screen 40-1 to the air conditioner control screen of the main screen 40-2, and FIG. 15(b) represents a change with time of an animation Q at the time when the focus is moved from the FM radio listen screen of the main screen 40-1 to the navigation menu screen of the main screen 40-3. For example, when the focus is moved from the main screen 40-1 to the main screen 40-2, the inside of the main screen changes from the FM radio listen screen to the air conditioner control screen with the movement of the main screen while the sound effect is outputted during the movement.

In this Embodiment 2, the time required to play back each animation during transition can be arbitrary. In the example shown in FIG. 14, the time required to play back the animation P is shorter than the time required to play back the animation Q.

An animation-during-transition controller 7 controls the playback speed of the animation during transition (i.e., the moving speed of the focus) which the animation-during-transition acquiring unit 5 acquires according to a control condition which a control condition storage 8 stores. The control condition storage 8 stores the control condition for determining the playback speed of the animation during transition. The control condition which the control condition storage 8 stores is shown in FIG. 16(a). The playback speed is determined according to the movement distance of the main screen 40, and, in this embodiment, the animation during transition is played back at a 1× speed when the movement distance is one with the movement distance from the position P1 to the position P2 being defined as a reference value. On the other hand, when the movement distance is twice as long as the reference value, like that from the position P1 to the position P3, the animation during transition is played back at a 2× speed. As a result, even if the movement distance is long, the movement of the focus put on the main screen 40 is completed within the same time period as that for the reference value.

Further, the animation-during-transition controller 7 can control the sound effect in such a way that the sound expresses the movement speed of the main screen 40 by increasing the playback speed or the pitch of the sound effect when the movement distance is long. Further, also when the movement of the main screen 40 is completed, a sound effect can be outputted to provide a sign for the user.

Although the information display device is structured in such a way as to control the playback speed of the animation during transition according to the movement distance in the example of FIG. 16(a), the information display device can be alternatively structured in such a way as to control a playback time duration, like that according to above-mentioned Embodiment 1. Hereafter, the example of controlling the playback time duration will be explained briefly.

Another example of the control condition which the control condition storage 8 stores is shown in FIG. 16(b). For example, when completing the movement time of the main screen 40 in the same screen in the same time independently upon the movement distance, the playback speed is controlled in such a way that the playback of every animation during transition is also completed within one second independently upon the movement distance. An animation during transition which is completed in one second or less can be completed within one second, and, in this case, the playback speed should just be controlled in such a way that the playback of only an animation during transition which takes one second or more is completed in one second.

The output unit 9 displays the animation during transition at the playback speed determined by the animation-during-transition controller 7, and also outputs the sound effect.

As mentioned above, the information display device according to Embodiment 1 is structured in such a way that the output unit 9 produces a screen display of a plurality of sub screens while arranging these sub screens according to the transition order, and displays the sub screen on which the focus is currently put as a large main screen, and the animation-during-transition table storage 6 stores, as the animations during transition, animations in each of which the main screen moves above the sub screens arranged on the screen of the output unit 9. Further, the animation-during-transition controller 7 is structured in such a way as to control the playback speed of the animation during transition according to either the movement distance of the main screen or the sum total of the duration of the animation during transition. Therefore, even when the movement distance of the focus is long, the animation during transition can be completed quickly and the ease of use is not impaired.

Although the example in which the main screen 40 showing the focus state is moved in a lateral direction within the same screen is shown in the above-mentioned explanation, the direction of movement is not limited to this lateral direction. Hereafter, variants will be explained. For example, the frequency of a radio station under channel selection is displayed at the center of the FM radio listen screen (display screen of the main screen 40-1) shown in FIG. 12(a). Numerals showing this frequency are aligned with a scale along the lateral direction of the screen, and an animation during transition in which the numerals and the scale are moved in the lateral direction is displayed according to a channel selection of a radio station. In the case of this structure, when the frequency of the radio station under channel selection and that of the next radio station which is selected according to a user operation are close to each other, the movement distance of the numerals and the scale is short, whereas when those frequencies are far apart from each other, the movement distance of the numerals and the scale is long. In such a screen display structure, the animation-during-transition controller 7 controls the playback speed of the animation during transition expressing the movement in the lateral direction of the numerals and the scale according to the difference (i.e., the movement distance) between the frequency of the current radio station and the radio station which is the transition destination. Therefore, slowness can be prevented from occurring before the completion of playback of the animation during transition.

Further, for example, the cabin interior temperature currently being set is displayed at the center of the air conditioner control screen (display screen of the main screen 40-2) shown in FIG. 12(b). A numeral string showing this cabin interior temperature is aligned in a vertical direction of the screen, and an animation during transition which the numeral string is moved in the vertical direction according to a user operation is displayed. In the case of this structure, when the cabin interior temperature currently being set and the preset temperature inputted according to a user operation are close to each other, the movement distance of the numeral string is short, when those temperatures are far apart from each other, the movement distance of the numeral string is long. In such a screen display structure, the animation-during-transition controller 7 controls the playback speed of the animation during transition expressing the movement in the vertical direction of the numeral string according to the difference (i.e., the movement distance) between the current preset temperature and a newly inputted preset temperature. Therefore, slowness can be prevented from occurring before the completion of playback of the animation during transition.

Further, for example, a map image is displayed in the navigation menu screen (display screen of the main screen 40-3) shown in FIG. 12(c). When changing the scale of this map image to an arbitrary scale, an animation during transition in which the map image under display is enlarged or reduced gradually to a map image having the arbitrary scale is displayed. Further, when displaying a map of an area surrounding an arbitrary point, an animation during transition in which the map image is moved from the current display point to the arbitrary point is displayed. In the case of this structure, when the current scale and the scale inputted according to a user operation are close to each other, the number of map images of scales which are displayed in the meantime decreases, whereas when the scales are far apart from each other, the number of map images increases. Similarly, when the current point and the arbitrary point which is the movement destination are close to each other, the movement distance is short, whereas when the point which is the movement destination is far apart, the movement distance is long. In such a screen display structure, the animation-during-transition controller 7 controls the playback speed of the animation during transition according to the difference between the scales or the distance between the points. Therefore, slowness can be prevented from occurring before the completion of playback of the animation during transition.

Further, for example, a text display of a voice recognition result of a user utterance (e.g., [symbol] A (konbini (convenience store) A) is produced in the facility name search screen 13 shown in FIG. 2. For example, when displaying the five characters of the voice recognition result “ [symbol] A (konbini (convenience store) A)” in the order of [symbol] (ko)→ [symbol] (n)→ [symbol] (bi)→ [symbol] (ni)→A, the animation-during-transition controller 7 can control the playback speed of the animation during transition expressing the text display according to the number of characters. As a result, while the method of displaying a text one character at a time is devised, the time required to display a text having a small number of characters can be made to be the same as that required to display a text having a large number of characters. Therefore, slowness can be prevented from occurring before the completion of display of the text.

Further, for example, in FIG. 17, an example of an animation during transition in which a plurality of objects 51 to 57 are displayed in a row in the same screen, and a movement of the focus is expressed by changing the sizes of the objects including from the object on which the focus is currently put to the object specified by the user is shown. In FIG. 17(a), the object 51 is selected according to a user operation and is enlarged displayed. When the object 54 is selected the next time in this state, the object 51 is reduced to its original size, the object 52 and the object 53 are enlarged and then reduced in order, and the object 54 is enlarged, so that the screen is made to make a transition to a state shown in FIG. 17(b).

Further, when the object 57 is selected in the state of FIG. 17(a), the object 51 is reduced to its original size, the objects 52 to 56 are enlarged and then reduced in order, and the object 57 is enlarged, so that the screen is made to make a transition to a state shown in FIG. 17(c).

In such a screen display structure, the animation-during-transition controller 7 controls the movement speed of the focus which is expressed by the change of the sizes of the objects according to the distance from the object under current selection to the object selected the next time. Therefore, even when the movement distance is long, slowness can be prevented from occurring before the completion of the animation during transition.

Further, for example, in FIG. 18, an example of an animation during transition in which a plurality of objects 61 to 63 are displayed in a row in the same screen, and a movement of the focus is expressed by changing the brightness of each object is shown. In FIG. 18(a), the object 61 is selected according to a user operation and is displayed brightly. When the object 62 is selected the next time in this state, the brightness of the object 61 is returned to its original value and the object 62 is brightened, so that the screen is made to make a transition to a state shown in FIG. 18(b).

Further, when the object 63 is selected in the state of FIG. 18(a), the brightness of the object 61 is returned to its original value, the object 62 is brightened and returned to its original value, and the object 63 is brightened, so that the screen is made to make a transition to a state shown in FIG. 18(c).

In such a screen display structure, the animation-during-transition controller 7 controls the movement speed of the focus which is expressed by a change in the brightness of each object according to the distance from the object under current selection to the object selected the next time. Therefore, even when the movement distance is long, slowness can be prevented from occurring before the completion of the animation during transition.

In a case in which the information display device in accordance with any one of above-mentioned Embodiments 1 and 2 is constructed of a computer, a display switching program in which the descriptions of the processes performed by the input unit 1, the transition position acquiring unit 2, the transition table storage 3, the transition path determinator 4, the animation-during-transition acquiring unit 5, the animation-during-transition table storage 6, the animation-during-transition controller 7, the control condition storage 8, and the output unit 9 are described can be stored in a memory of the computer, and a CPU of the computer can be made to execute the display switching program stored in the memory.

In addition, while the invention has been described in its preferred embodiments, it is to be understood that an arbitrary combination of two or more of the embodiments can be made, various changes can be made in an arbitrary component in accordance with any one of the embodiments, and an arbitrary component in accordance with any one of the embodiments can be omitted within the scope of the invention.

### INDUSTRIAL APPLICABILITY

As mentioned above, because the information display device in accordance with the present invention controls the playback speed of the animation during transition which is displayed at the time of a shortcut operation, the information display device is suitable for use in GUIs of a car navigation system, an electrical household appliance, and FA equipment which have menus with a hierarchical structure.

### EXPLANATIONS OF REFERENCE NUMERALS

1 input unit, 2 transition position acquiring unit, 3 transition table storage, 4 transition path determinator, 5 animation-during-transition acquiring unit, 6 animation-during-transition table storage, 7 animation-during-transition controller, 8 control condition storage, 9 output unit, 10 top screen, 11 navigation menu screen, 12 destination search menu screen, 13 facility name search screen, 14 facility name search result screen, 22 surrounding facility list screen, 23 shopping list screen, 24 convenience store list screen, 25 all-convenience-stores list screen, 31 FM radio listen screen, 40 and 40-1 to 40-3 main screen, 41 audio sub screen, 42 air conditioner sub screen, 43 navigation sub screen, 51 to 57 and 61 to 63 object.

1. An information display device comprising:
a transition table storage that stores a transition order of a plurality of objects;
an animation-during-transition table storage that stores animations during transition each of which is to be displayed when moving a focus from an arbitrary object to a another object according to said transition order;
an inputter that accepts a specification of an object to which the focus is to be moved from outside the information display device;
a transition path determinator that determines a transition path leading from an object on which the focus is currently put to the transition destination object for which the focus specification is accepted by said inputter on a basis of said transition order;
an animation-during-transition acquiring unit that acquires an animation during transition between objects existing on the transition path determined by said transition path determinator from said animation-during-transition table storage;
an animation-during-transition controller that controls a playback speed of each of at least one animation during transition acquired by said animation-during-transition acquiring unit according to either a number of objects existing on the transition path determined by said transition path determinator or a sum total of a time duration of said at least one animation during transition in such a way that a playback of the animation is completed in a predetermined time; and
an outputter that displays each animation during transition acquired by said animation-during-transition acquiring unit at the playback speed controlled by said animation-during-transition controller when moving the focus from said object on which the focus is currently put to the object which is said transition destination.

2. The information display device according to claim 1, wherein said output unit produces a screen display of only the object, among a plurality of objects, on which the focus is currently put, and said animation-during-transition table storage stores, as the animations during transition, animations each transitioning between objects arranged in the transition order toward a depth direction perpendicular to a screen of said outputter.

3. The information display device according to claim 1, wherein said outputter produces a screen display of a plurality of objects while arranging these objects according to the transition order, and displays the object on which the focus is currently put in a display form different from those of the other objects, and said animation-during-transition table storage stores, as the animations during transition, animations in each of which the focus moves between said objects arranged on a screen of said outputter.

4. The information display device according to claim 3, wherein said animation-during-transition controller controls the playback speed of each animation during transition according to a distance moved by the focus.

5. The information display device according to claim 1, wherein said outputter synchronously outputs a number of sound effects which is the same as a number of animations during transition.

6. A display switching method comprising:
an inputting step of accepting a specification of an object, among a plurality of objects for which a transition order is defined, on which a focus is to be put from outside;
a transition path determining step of determining a transition path leading from an object on which the focus is currently put to the transition destination object for which the focus specification is accepted in said inputting step on a basis of said transition order;
an animation-during-transition acquiring step of acquiring an animation during transition between objects existing on the transition path determined in said transition path determining step from an animation-during-transition table storage that stores animations during transition each of which is to be displayed when moving the focus from an arbitrary object to another object according to said transition order;
an animation during transition controlling step of controlling a playback speed of each of at least one animation during transition acquired in said animation-during-transition acquiring step according to either a number of objects existing on the transition path determined in said transition path determining step or a sum total of a time duration of said at least one animation during transition in such a way that a playback of the animation is completed in a predetermined time; and
an outputting step of displaying each animation during transition acquired in said animation-during-transition acquiring step at the playback speed controlled in said animation-during-transition controlling step when moving the focus from said object on which the focus is currently put to the object which is said transition destination.

7. A display switching program for making a computer implement:
a transition table storage that stores a transition order of a plurality of objects;
an animation-during-transition table storage that stores animations during transition each of which is to be displayed when moving a focus from an arbitrary object to another object according to said transition order;
an inputter that accepts a specification of an object to which the focus is to be moved from outside the display switching program;
a transition path determinator that determines a transition path leading from an object on which the focus is currently put to the transition destination object for which the focus specification is accepted by said inputter on a basis of said transition order;
an animation-during-transition acquiring unit that acquires an animation during transition between objects existing on the transition path determined by said transition path determinator from said animation-during-transition table storage;
an animation-during-transition controller that controls a playback speed of each of at least one animation during transition acquired by said animation-during-transition acquiring unit according to either a number of objects existing on the transition path determined by said transition path determinator or a sum total of a time duration of said at least one animation during transition in such a way that a playback of the animation is completed in a predetermined time; and
an outputter that displays each animation during transition acquired by said animation-during-transition acquiring unit at the playback speed controlled by said animation-during-transition controller when moving the focus from said object on which the focus is currently put to the object which is said transition destination.
